(19) United States
(12) Patent Application Publication
(10) Pub. No.: US 2014/0196847 A1
(43) Pub. Date: Jul. 17, 2014

(54) CONDUCTIVE AQUEOUS-BASED ADHESIVE COMPOSITIONS AND METHODS OF USE THEREOF

(71) Applicant: Brent Bergherm, Euharlee, GA (US)

(72) Inventor: Brent Bergherm, Euharlee, GA (US)

(73) Assignee: RAINFOREST TECHNOLOGIES, LLC, Las Vegas, NV (US)

(21) Appl. No.: 14/154,284

(22) Filed: Jan. 14, 2014

Related U.S. Application Data
(60) Provisional application No. 61/752,491, filed on Jan. 15, 2013.

(51) Int. Cl. C09J 9/02; C09J 5/00

(52) U.S. Cl. CPC C09J 9/02; C09J 5/00
USPC 156/334; 252/510; 252/511; 156/325

(57) ABSTRACT

Described herein are conductive aqueous-based adhesive compositions that comprise (a) an aqueous-based adhesive and (b) carbon black, graphite, or a combination thereof. The aqueous-based adhesive compositions are particularly effective at preventing the buildup of static charge and at reducing electrostatic discharge events. In certain aspects, the aqueous-based adhesive compositions can be mixed with propellants and applied to substrates using an aerosol delivery system. The aqueous-based adhesive compositions described herein can readily be adhered to any substrate such as, for example, floors, walls, ceilings, and the like.

### CROSS REFERENCE TO RELATED APPLICATIONS

This application claims priority to U.S. Provisional Patent Application Ser. No. 61/752,491, filed Jan. 15, 2013, which is hereby incorporated herein by reference in its entirety for all purposes.

### BACKGROUND

Static charge is created when, for example, two insulators rub together and then separate. One of the insulators gains electrons, while the other loses them. An unbalanced (static) charge is thus created. This static charge can then move from one surface to another, either when the two surfaces touch or when the insulating capacity of the medium separating the two surfaces (e.g. air) is exceeded. This movement of static charge is termed electrostatic discharge, or ESD.

An ESD event of as little as 5V damages telephone equipment, circuit boards, networked computers, medical devices, and the like. However, a person might not be aware of the presence of such a danger, since ESD has to reach a threshold of about 3,000 to 3,500V to be felt as a shock. ESD has become a greater problem in the past two decades as the demand for smaller electronic devices has increased. Smaller devices allow less room for on-chip ESD protection. Further, a small ESD event might not damage a device enough for the damage to be detectable during factory testing procedures, but might cause latent damage and intermittent device failure in the future. Multiple small ESD events can lead to permanent failure of an electronic device.

Certain types of environments are particularly vulnerable to ESD damage. Among these are call centers, data centers, offices, facilities where electronics are manufactured, air traffic control centers, clean rooms, and hospitals (especially MRI suites and operating rooms). Various protective measures have been put into place, but many of these have drawbacks. ESD-protective footwear, wrist straps, foot straps, grounding mats, special clothing, removal of insulators such as plastics from the work area, and even ESD-protective chairs are collectively part of an effective ESD management system.

ESD flooring systems are an integral part of any ESD system. Multiple types of ESD flooring exist, and the choice among them can be difficult. ESD rubber floors are easy to maintain and noise-dampening, but have a high initial cost that may deter many purchasers. Modern technology has resulted in ESD carpet materials that can be reliably grounded, but carpet has low solvent resistance and it can be difficult to roll heavy, wheeled equipment (gurneys, forklifts, portable medical devices, etc.) over carpet. ESD vinyl has been developed that can be quite effective, but it is subject to wear and can still hold static charge, particularly when individuals wear standard footwear or on days when ambient humidity is low. ESD epoxy floors are difficult to to maintain and can be slippery. Further, they tend to discolor and thus may not be aesthetically pleasing.

The ESD flooring systems described above generally require the use of an adhesive in order to adhere the flooring material to the floor or other substrate of interest. In order for the flooring system to comply with ESD standards, the adhesive should also be conductive. Here, the conductive adhesive acts as a ground plane, providing electrical continuity between the ESD flooring material (e.g., tiles). In addition, static electricity is directed away from the surface of the ESD flooring material into the ground with the conductive adhesive, which facilitates the movement of static electricity.

Traditional adhesives such as, for example, those packaged in aerosol cans, have been solvent-based compounds because of the high solubility of adhesive compounds in the solvents and because of the low cost of such systems. The majority of these traditional systems usually contain at least some volatile organic compounds (VOCs) and/or exhibit some level of flammability. Solvent-based systems also usually carry with them a number of undesirable health hazards and environmental concerns. Governmental regulations have been tightening the requirements for chemical-based products with respect to VOCs and it would be desirable if aqueous-based ESD-protective adhesive compositions existed that contained fewer VOCs and were therefore more environmentally friendly. It would therefore be desirable to improve the ESD-protective performance of flooring systems and other construction and interior design materials using conductive adhesives with improved electrical and physical properties.

### SUMMARY

Described herein are aqueous-based adhesive compositions that include (a) an aqueous-based adhesive and (b) carbon black, graphite, or a combination thereof. The aqueous-based adhesive compositions are particularly effective at preventing the buildup of static charge and reducing electrostatic discharge events. In certain aspects, the adhesive compositions can be mixed with propellants and applied to substrates using an aerosol delivery system. The aqueous-based adhesive compositions described herein can readily be adhered to any substrate such as, for example, floors, walls, ceilings, and the like. Optional additives that are known in the to art may also be included.

The advantages of the materials, methods, and devices described herein will be set forth-in part in the description which follows, or may be learned by practice of the aspects described below. The advantages described below will be realized and attained by means of the elements and combinations particularly pointed out in the appended claims. It is to be understood that both the foregoing general description and the following detailed description are exemplary and explanatory only and are not restrictive.

### DETAILED DESCRIPTION

The compositions, methods, and articles described herein can be understood more readily by reference to the following detailed description. It is also to be understood that the terminology used herein is for the purpose of describing particular aspects only and is not intended to be limiting.

It must be noted that, as used in the specification and the appended claims, the singular forms “a,” “an,” and “the” include plural referents unless the context clearly dictates otherwise. Thus, for example, reference to “a propellant” includes mixtures of two or more propellants.

“Optional” or “optionally” means that the subsequently described event or circumstance can or cannot occur, and that the description includes instances where the event or circumstance occurs and instances where it does not. For example, the phrase “optionally includes a fungicide” means that a fungicide can or cannot be included.

As used herein, the term “about” is used to provide flexibility to a numerical range endpoint by providing that a given value may be “a little above” or “a little below” the endpoint without affecting the desired result.

“Electrostatic discharge” or “ESD” refers to the sudden, spontaneous transfer of electric current. An ESD event may result in a small shock to a human or a discharge that can damage electronic equipment. The range of ESD can be from 1 volt up to 5,000 volts.

An “aqueous-based” adhesive and adhesive composition as referred to herein includes water. For example, the aqueous-based adhesive composition can be composed of at least 10%, 20%, 30%, 40%, 50%, 60%, 70%, 80%, or 90% by weight water. In one aspect, an aqueous-based composition includes water (i.e., 100%) as the only solvent. In another aspect, an aqueous-based composition includes water and one or more co-solvents.

As used herein, an “adhesive” is a compound or composition or other material that, when applied to two items or surfaces, bonds them together. In one aspect, an adhesive cures when a chemical reaction occurs between two of its components. In another aspect, an adhesive cures upon the evaporation of a solvent or other volatile compound. In a further aspect, the adhesive can be pressure sensitive, thermoplastic, UV-curable, or any other type of adhesive known in the art. In one aspect, the adhesives are part of an emulsion composed of water, which is an example of an aqueous-based adhesive.

A “surfactant” is an organic compound that may be derived from a natural product, or may result from chemical modification of a natural product, or may be completely chemically synthesized. Surfactants typically contain hydrophilic head groups and hydrophobic tails. In one aspect, the head group is anionic, cationic, non-ionic, or zwitterionic. In another aspect, the tail is composed of a hydrocarbon or a glucoside. Surfactants alter the surface tension of liquids and may form micelles or bilayers in aqueous solution. Many applications of surfactants are known in the art. Surfactants are, for example, commonly employed as emulsifiers, detergents, wetting agents, and in other related uses.

As used herein, “powder” or “powdered” refers to a collection of fine, freely-flowing particles and “granule” or “granular” refers to a macroscopic agglomerate of interacting particles. Both graphite and carbon black can exist in granular and powdered forms.

“Dispersant” or “dispersing agent” refers to a chemical compound that assists in keeping the particles of a material separated from one another when they are distributed in a medium in which they would otherwise agglomerate. Dispersants are also believed to act as wetting agents. Dispersants may be ionic (anionic or cationic), non-ionic, or amphoteric. Without wishing to be bound by theory, the charged groups to within the ionic dispersant coats a particle, and imparts a net charge to the particle surface. Here, the net charges on all like particles are all positive or all negative, the particles will therefore repel one another. Meanwhile, also not wishing to be bound by theory, a non-ionic dispersant can include a high molecular weight polymer with a polar group. The polar group interacts with the particle to be dispersed through hydrogen bonding, dipole-dipole interactions, London dispersion forces, and/or van der Waals interactions, while the high molecular weight component possesses sufficient bulk to achieve separation of dispersed particles due to steric effects.

As used herein, a “stabilizer” is any constituent of the aqueous-based adhesive compositions disclosed herein that has the effect of inhibiting degradation of the compositions and/or inhibiting reactions among the components of the compositions. In another aspect, a stabilizer may help to preserve an emulsion and prevent it from separating. In a further aspect, a stabilizer may act as an antioxidant or a UV protectant.

As used herein, a “defoamer” is a chemical added to the aqueous-based adhesive compositions disclosed herein to reduce and/or hinder foam formation in the composition.

A “filler” is any constituent of the aqueous-based adhesive compositions and disclosed herein that adds bulk to the compositions without significantly increasing the amount of active compounds involved in the compositions. In some aspects, filler may enhance selected properties of the compositions disclosed herein.

A “biocide” as used herein is any chemical substance or composition that kills, removes, inhibits the growth of, or renders harmless any microorganism that has the potential to cause harm. Biocide is a general term that includes, but is not limited to, fungicides, algicides, antifungals, antibacterials, and the like, as well as mixtures thereof.

A “fungicide” is a chemical substance or composition that kills, removes, inhibits the growth of, or renders harmless, fungi and/or fungal spores.

A “preservative” as used herein is any substance added to the aqueous-based adhesive compositions disclosed herein, wherein the substance prevents chemical changes (e.g., discoloration, loss of tack) or prevents decomposition as a result of microbial activity.

“Hydrocarbon” refers to any organic compound made up entirely of hydrogen and carbon atoms. A hydrocarbon may be linear, branched, or cyclic; saturated or unsaturated; aromatic or non-aromatic; or any combination thereof.

As used herein, “mineral oil” refers to a mixture of alkanes obtained from a non-animal and non-vegetable source. These alkanes typically contain from 15 to 40 carbons and are colorless and odorless. The mineral oil may be untreated, mildly refined, or highly refined.

As used herein, “volatile organic compound” refers to any compound exhibiting a high vapor pressure (and corresponding low boiling point) at room temperature.

“Admixing” or “admixture” refers to a combination of two or components together wherein there is no chemical reaction or physical interaction. The terms “admixing” and “admixture” can also include the chemical reaction or physical interaction between any of the components described herein upon mixing to produce the composition. The components can be admixed alone, in water, in another solvent, or in a combination of solvents.

As used herein, a plurality of items, structural elements, compositional elements, and/or materials may be presented in a common list for convenience. However, these lists should be construed as though each member of the list is individually identified as a separate and unique member. Thus, no individual member of such list should be construed as a de facto equivalent of any other member of the same list solely based on its presentation in a common group, without indications to the contrary.

Concentrations, amounts, and other numerical data may be expressed or presented herein in a range format. It is to be understood that such a range format is used merely for convenience and brevity and thus should be interpreted flexibly to include not only the numerical values explicitly recited as the limits of the range, but also to include all the individual numerical values or sub-ranges encompassed within that range as if each numerical value and sub-range was explicitly recited. As an illustration, a numerical range of “about 1 to about 5” should be interpreted to include not only the explicitly recited values of about 1 to about 5, but also to include individual values and sub-ranges within the indicated range. Thus, included in this numerical range are individual values such as 2, 3, and 4, and sub ranges such as from 1-3, from 2-4, and from 3-5, etc., as well as 1, 2, 3, 4, and 5, individually. The same principle applies to ranges reciting only one numerical value as a minimum or a maximum. Furthermore, such an interpretation should apply regardless of the breadth of the range or the characteristics being described.

Disclosed are materials and components that can be used for, can be used in conjunction with, can be used in preparation for, or are products of the disclosed compositions and methods. These and other materials are disclosed herein, and it is understood that when combinations, subsets, interactions, groups, etc. of these materials are disclosed, that while specific reference of each various individual and collective combination and permutation of these compounds may not be explicitly disclosed, each is specifically contemplated and described herein. For example, if a carbon black dispersion is disclosed and discussed and a number of different surfactants are discussed, each and every combination and permutation of carbon black dispersion and surfactant that is possible is specifically contemplated unless specifically indicated to the contrary. For example, if a class of molecules A, B, and C are disclosed, as well as a class of molecules D, E, and F, and an example of a combination A+D is disclosed, then even if each is not individually recited, each is individually and collectively contemplated. Thus, in this example, each of the combinations A+E, A+F, B+D, B+E, B+F, C+D, C+E, and C+F, are specifically contemplated and should be considered disclosed from disclosure of A, B, and C; D, E, and F; and the example combination of A+D. Likewise, any subset or combination of these is also specifically contemplated and disclosed. Thus, for example, the sub-group of A+E, B+F, and C+E is specifically contemplated and should be considered disclosed from disclosure of A, B, and C; D, E, and F; and the example combination of A+D. This concept applies to all aspects of this disclosure including, but not limited to, steps in methods of making and using the disclosed compositions. Thus, if there are a variety of additional steps that can be performed with any specific embodiment or combination of embodiments of the disclosed methods, and that each such combination is specifically contemplated and should be considered disclosed.

The amount of each component unless expressed otherwise is based upon the batch adhesive composition. For example, if a polymer is from 5% to 70% by weight of the composition, it is 5% to 70% by weight of the adhesive prior to the addition of other components such as, for example, a propellant.

### Aqueous-Based Adhesive Compositions

Described herein are aqueous-based adhesive compositions that include (a) an aqueous-based adhesive and (b) carbon black, graphite, or a combination thereof. Each component is described in detail below, as are methods of making and using the adhesive compositions.

### A. Adhesives

Various aqueous-based adhesives can be used herein. In one aspect, the aqueous-based adhesive includes an acrylic emulsion, an acrylic copolymer emulsion, a carboxylated styrene butadiene rubber (SBR) emulsion, or a styrene acrylic copolymer emulsion. In one aspect, prior to admixing with the carbon black and/or graphite, the polymers are water-based emulsions. Various polymers can be used in the aqueous-based adhesive emulsions. In one aspect, the acrylic emulsion can be a product sold under any of the trade names Rhoplex® AC-234, Rhoplex® AC-264, Rhoplex® B-60A, Rhoplex® E-358, Rhoplex® HA-16, Rhoplex® N-580, Rhoplex® N-619, or Rhoplex® N-1031 manufactured by the Rohm and Haas Corporation; Orgal KY 9000, manufactured by Organikkimya; UCAR® Latex 163S, manufactured by Union Carbide; Saitack® 950 or Saitack® 970, manufactured by Saiden Technologies; Hycar® 26084, Hycar® 26091, Hycar® 26315, Hycar® 26373, Hycar® 26447, or Hycar® 26450, all manufactured by the B.F. Goodrich Corporation; Jagotex® KEA-5040 or Jagotex® KEA-5050, manufactured by the Jager Company; or Flexcryl® FL2585, Flexcryl® FLGP5, Flexcryl® FLGP25, Flexcryl® FLLC14, or Flexcryl® FLSL23, all manufactured by Air Products and Chemicals, Inc. In another aspect, the acrylic emulsion may comprise a carboxylated acrylic polymer such as Acronal® 3432, manufactured by the BASF Corporation.

In other aspects, the acrylic copolymer emulsion can be an acrylate-acrylonitrile dispersion, an ethylene-acrylic acid dispersion, or another acrylate copolymer dispersion. In one aspect, the acrylate-acrylonitrile dispersion can be a product sold under the trade names Saitek® 400, manufactured by Saiden Technologies; or Acronal® 35D, Acronal® 81D, Acronal® A200, Acronal® A220, Acronal® A280, Acronal® A323, Acronal® A378, Acronal® A380, Acronal® B37D, or Acronal® DS3390, all manufactured by the BASF Corporation. In an alternative aspect, the ethylene-acrylic acid dispersion can be products sold under the trade names Adcote® 50T4983 or Adcote® 50T4990, both manufactured by Morton International. In another alternative aspect, the other acrylate copolymer dispersion can be products sold under the trade names Acronal® 210 or Acronal® V275, both manufactured by the BASF Corporation.

In other aspects, the styrene-acrylic copolymer emulsion can be an anionic styrene-acrylic copolymer emulsion. Suitable commercial examples of such an emulsion include, but are not limited to: Acronal® 296D, Acronal® NX-4876, Acronal® S 305D, Acronal® S 400, Acronal® S 610, Acronal® S 702, Acronal® S 714, Acronal® S 728, Acronal® 5760, or Acronal® V 213, all manufactured by the BASF Corporation; Vancryl® 937, Vancryl® 954, or Vancryl® 989, manufactured by Air Products and Chemicals, Inc.; Texigel® 13-031, Texigel® 13-034, or Texigel® 13-57, manufactured by Scott Bader, Inc.; Synthemul® 40402 or Synthemul® 40403, manufactured by Reichold Chemicals Company; Carboset® CR-760 manufactured by the B.F. Goodrich Company; Rhoplex® NW-1715K, Rhoplex® P-308, or Rhoplex® P-376, manufactured by the Rohm and Haas Company; or Saiden® SA-207, manufactured by Saiden Technologies.

In further aspects, the styrene-acrylic copolymer emulsion can further include acrylonitrile units. Suitable commercial examples of such an emulsion include, but are not limited to: Acronal® DS 2285X, Acronal S 504, and Acronal® S 886S, all manufactured by the BASF Corporation. In still further aspects, the styrene-acrylic copolymer emulsion can be silanated. Suitable commercial examples of such an emulsion include Acronal® S 710 manufactured by the BASF Corporation and Texigel® 13-057, manufactured by Scott Bader, Inc.

The polymers in some aspects can be derived from monomers such as (meth)acrylic acid, C1 to C8 alkyl (meth)acrylate, or C1 to C13 to hydroxyalkyl(meth)acrylate. In one aspect, the adhesive can include Saitack® 970. Other adhesives having properties similar to those of Saitack® 970 can be used herein. In one aspect, the adhesive can include from about 65 to about 75% polymer solids, having a pH of from about 5.0 to about 6.0, a Brookfield RVF viscosity of less than 1000 cps, a density of about 8 to 9 lbs/gallon, and possess a T_{g} of about −40 to −50° C.

In another aspect, the aqueous-based adhesive can be one or more acrylates not heretofore discussed. Acrylates useful herein include, but are not limited to, isooctyl acrylate, 4-methyl-2-pentyl acrylate, 2-methylbutyl acrylate, isoamyl acrylate, sec-butyl acrylate, isodecyl methacrylate, tert-butyl acrylate, isobornyl acrylate, butyl methacrylate, n-butyl acrylate, 2-ethylhexyl acrylate, trimethylol propane triacrylate, pentaerythritol triacrylate, ethylene glycol diacrylate, diethylene glycol diacrylate, 1,6-hexanediol diacrylate, ethyl hexyl acrylate, beta-carboxyethylacrylate, 2-phenoxyethyl acrylate, poly(ethylene-co-glycidylmethacrylate), poly(ethylene-co-methyl(meth)acrylate-co-glycidyl acrylate), poly(ethylene-co-n-butyl acrylate-co-glycidyl acrylate), poly(ethylene-co-methyl acrylate), poly(ethylene-co-ethyl acrylate), poly(ethylene-co-butyl acrylate), poly(ethylene-co-(meth)acrylic acid), metal salts of poly(ethylene-co-(meth)acrylic acid), the corresponding (meth)acrylates, mixtures thereof, and polymers and/or copolymers thereof.

In a further aspect, the aqueous-based adhesive can be an anionic acrylate. In one aspect, the adhesive can be from about 50 to about 60% polymer solids, having a pH of from about 7.5 to about 9, a Brookfield RVF viscosity of about 100-200 cps, a density of about 0.5 to 1.5 g/mL, and possess a T_{g} of about −25 to −43° C. Suitable commercial examples include Orgal KY 9000 manufactured by Organikkimya 9000, Rhoplex N-580 and Rhoplex N-619, both manufactured by Rohm & Haas.

Various percentages by weight of aqueous-based adhesive can be used herein. In one aspect, the aqueous-based adhesive (e.g., adhesive in a dispersion or emulsion) can be from about 10% to about 90% by weight of the aqueous-based adhesive compositions. In another aspect, the aqueous-based adhesive can be from about 45% to about 85% of the present compositions. In a further aspect, the aqueous-based adhesive can be from about 55% to about 70% of the present compositions. In another aspect, the aqueous-based adhesive can be from about 55% to about 60% of the present compositions.

In another aspect, the adhesive (dry polymer) can be from about 10% to about 90% by weight of the aqueous-based adhesive compositions. In another aspect, the adhesive can be from about 10% to about 50% of the composition. In a further aspect, the adhesive can be from about 10% to about 40% of the composition.

In certain aspects, the aqueous-based adhesive can be two or more different polymers having different glass transition temperatures. In one aspect, the aqueous-based adhesive can be a mixture of:
(a) a first polymer having a glass transition temperature greater than 15° C.; and
(b) a second polymer having a glass transition temperature less than 0° C.

The first polymer provides cohesive and strength properties to the adhesive composition. In general, the first polymer is composed of one or more polymers having a relatively high glass transition temperature (T_{g}). Thus, the first polymer is a “hard” polymer, which requires higher temperatures to soften the polymer relative to the second polymer. In certain aspects, it is desirable that the first polymer absorb little to no water. This is particularly useful when applied to substrates such as, for example, drywall, where the presence of water can generate mold and compromise the drywall.

In one aspect, the first polymer has a glass transition temperature greater than 15° C. In another aspect, the glass transition temperature is from 15° C. to 25° C. or from 20° C. to 25° C. In further aspects, the glass transition temperature of the first polymer is 15° C., 16° C., 17° C., 18° C., 19° C., 20° C., 21° C., 22° C., 23° C., 24° C., or 25° C., where any value can form a lower and upper end-point of a temperature range.

A variety of different polymers can be used as the first polymer. For example, the first polymer can be derived from monomers such as (meth)acrylic acid, C1 to C8 alkyl (meth)acrylate, C1 to C13 hydroxyalkyl(meth)acrylate, di-C1 to C13 alkyl maleate/fumarate, vinyl ester such as vinyl acetate, styrene, butadiene, 2-chloro-1,3-butadiene, and ethylene. In one aspect, the first polymer comprises a styrene acrylic latex polymer. Examples of such polymers include, but are not limited to, Acronal® 296D (copolymer dispersion of butyl acrylate and styrene), Acronal® S 702 (acrylic-styrene copolymer anionic dispersion), and Acronal® S 728 (copolymer of styrene-butyl acrylate aqueous dispersion), which are manufactured by BASF. Another example includes Saiden® SA-207 (styrene acrylic) manufactured by Saiden Technologies. In other aspects, the first polymer is a polyester polyurethane such as, for example, a carboxylated or sulfonated polyester polyurethane. The amount of first polymer can vary depending upon the application of the adhesive as well as the selection and amounts of other components used to make the adhesive. In one aspect, the first polymer is from 30% to 90% by weight of the composition. In other aspects, the first polymer is from 30% to 80%, 30% to 70%, 30% to 50%, 60% to 80%, or 70% to 80% by weight of the composition.

The aqueous-based adhesive can also include a second polymer having a glass transition temperature less than 0° C. Due to the lower glass transition temperature, the second polymer is “softer” than the first polymer. Not wishing to be bound by theory, the second polymer provides a good balance of cohesion (i.e., strength) and tackiness. It is also desirable that the second polymer absorb little to no water for the reasons discussed above.

In one aspect, the second polymer has a glass transition temperature from −10° C. to −50° C. or from −30° C. to −40° C. In another aspect, the second polymer has a glass transition temperature less than −30° C. In further aspects, the glass transition temperature of the second polymer is −30° C., −31° C., −32° C., −33° C., −34° C., −35° C., −36° C., −37° C., −38° C., −39° C., −40° C., −41° C., −42° C., −43° C., −44° C., −45° C., −46° C., −47° C., −48° C., −49° C., −50° C., −51° C., −52° C., −53° C., −54° C., −55° C., −56° C., −57° C., −58° C., −59° C., −60° C., −61° C., −62° C., −63° C., −64° C., −65° C., where any value can form a lower and upper end-point of a temperature range.

In one aspect, the second polymer can be an acrylic based polymer. Examples of second polymers useful herein include, but are not limited to, Acronal® V 275 (acrylic-vinyl acetate copolymer emulsion), Acronal® 3432 (a dispersion of a carboxylated acrylic polymer), Acronal® 210 (an acrylate copolymer emulsion), Acronal° A 200, Acronal° A 280, Acronal° A 323, Acronal° A 378, Acronal° A 380, and Acronal® V 312, which are manufactured by BASF. Others include and Saiden Saitak® 950 (acrylic) and 400™ (acrylonitrile/acrylic copolymer) manufactured by Saiden Technologies and UCAR® latex 163S (acrylic) manufactured by Union Carbide. The amount of second polymer can vary depending upon the application of the adhesive as well as the selection and amounts of other components used to make the adhesive. In one aspect, the second polymer is from 5% to 70% by weight of the composition. In other aspects, the first polymer is from 10% to 70%, 20% to 70%, 30% to 70%, or 40% to 70% by weight of the composition.

In one aspect, the second polymer can include two or more different polymers with varying glass transition temperatures. By selecting the appropriate second polymers, it is possible to vary the cohesive and tack properties of the adhesive composition. In one aspect, the second polymer includes two polymers, where one of the polymers has a glass transition temperature from −30° C. to −40° C. and the other polymer has a glass transition temperature less than −40° C. or from −40° C. to −65° C. In another aspect, the second polymer includes three polymers, where two of the polymers have a glass transition temperature from −30° C. to −40° C. and the third polymer has a glass transition temperature less than −40° C. or from −40° C. to −65° C.

In another aspect, the second polymer can include two or more acrylic based polymers. In certain aspects, the additional second polymer can provide additional tack properties to the adhesive composition. In one aspect, one of the second polymers can be a polymer or copolymer derived from alkyl acrylates such as, for example, n-butyl acrylate or 2-ethylhexyl acrylate. Not wishing to be bound by theory, by using polymers derived from varying amounts of an alkyl acrylate, it is possible vary the softness and, ultimately, the tack properties of the adhesive. In one aspect, the second polymer having a glass transition temperature less than −40° C. includes Acronal® 81D (acrylic copolymer emulsion containing acrylonitrile in the polymer backbone) manufactured by BASF and Saitack® 400 (acrylonitrile/acrylic copolymer) manufactured by Saiden technologies.

In one aspect, the second polymer can include an acrylic/vinyl acetate co-polymer (e.g., Acronal® V 275) and a carboxylated acrylic polymer (e.g., Acronal 3432). In this example, the acrylic/vinyl acetate co-polymer provides more cohesion and less tack, and the carboxylated acrylic polymer provides additional tack. In this aspect, when the second polymer is composed of an acrylic/vinyl acetate co-polymer and carboxylated acrylic polymer, the acrylic/vinyl acetate co-polymer can be present to in the adhesive in an amount of 40% to 65% by weight and the carboxylated acrylic polymer can be present in an amount from 5% to 15% by weight of the adhesive.

### B. Carbon Black

In one aspect, the aqueous-based adhesive compositions described herein include carbon black. Carbon black has a surface-area-to-volume ratio that is considered high and that falls between the surface-area-to-volume ratios of activated carbon and soot. In general, carbon black has a low polycyclic aromatic hydrocarbon content.

In one aspect, the carbon black can be a powder, granule, or a combination thereof. In some aspects, the carbon black can form aggregates and agglomerates. Not wishing to be bound by theory, during the production of carbon black, some particles fuse together in the combustion reactor, forming aggregates. Weak intermolecular forces may cause some of these aggregates to agglomerate. Increases in aggregation and/or agglomeration lead to corresponding decreases in surface area and may further improve the dispersion qualities of the carbon black.

In another aspect, the carbon black can be admixed with the aqueous-based adhesive as a dry solid. In an alternative aspect, the carbon black can be admixed with the aqueous-based adhesive as part of an aqueous dispersion.

In one aspect, at least 90% of the carbon black has a particle size of less than 20 μm. In another aspect, at least 90% of the carbon black can has a particle size of 1 μm to 20 μm, 2 μm to 20 μm, 5 μm to 20 μm, or 10 μm to 20 μm.

In one aspect, the carbon black can be granular and possess a BET nitrogen surface area of about 10 to about 1,300 m²/g as measured by ASTM D3037. In a further aspect, the BET nitrogen surface area can be from about 10 to about 500 m²/g or from about 25 to about 100 m²/g.

In another aspect, the carbon black has an oil absorption number (OAN) of from about 100 to about 500 mL/100 g as measured by ASTM D2414. In a further aspect, the OAN can be from about 100 to about 250 mL/100 g.

In still another aspect, the carbon black has a crushed oil absorption number (COAN) of from about 50 to about 500 mL/100 g as measured by ASTM D2414. In a further aspect, the COAN can be from about 50 to about 150 mL/100 g.

In another aspect, the carbon black has a pore density of from about 125 to about 225 kg/m³ as measured by ASTM D1513. In a further aspect, the pore density can be from about 150 to about 200 kg/m³.

Suitable carbon black preparations include, but are not limited to, Ensaco® granular and/or powdered carbon blacks sold by Timcal, and W-7017 Aurasperse® Carbon Black Pigment Dispersion sold by BASF.

In one aspect, the carbon black is an aqueous dispersion. In one aspect, the aqueous carbon black dispersion has from about 30 to about 60% by weight carbon black, from about 0.5 to about 1.5% butoxyethanol, from about 0.5 to about 1.5% 2,2′-iminodiethanol, and from about 0.1 to 1.0% of heavy paraffinic petroleum distillates.

In an alternative aspect, the carbon black is added to the aqueous-based adhesive as a solid. In one aspect, carbon black having CAS no. 1333-86-4 can be used herein. In one aspect, the carbon black can be Ensaco® 150 granular carbon black, Ensaco® 150 powdered carbon black, or a mixture thereof. In one aspect, the carbon black can be Ensaco® 210 granular carbon black, Ensaco® 210 powdered carbon black, or a mixture thereof. In one aspect, the carbon black can be Ensaco® 250 granular carbon black, Ensaco® 250 powdered carbon black, or a mixture thereof. In one aspect, the carbon black can be Ensaco® 260 granular carbon black, Ensaco® 260 powdered carbon black, or a mixture thereof. When the carbon black is added as a solid to the aqueous-based adhesive, in one aspect, a dispersant or dispersing agent can also be used. In one aspect, the dispersant may be an ionic dispersant. In a preferred aspect, the ionic dispersant can be an anionic dispersant such as, for example, a polycarboxylic polymer. In one aspect, the dispersant can be from about 20 to about 30% polymer solids, having a pH of from about 10.5 to about 11.5, and a Brookfield RVF viscosity of about 4,000 cps. In one aspect, the ionic dispersant can be COADIS™ 123K dispersant manufactured by Coatex. In an alternative aspect, the dispersant can be a nonionic dispersant.

In a further aspect, the nonionic dispersant can be a polyurethane or a polyacrylate. In one aspect, the dispersant can range from about 10% to about 20%, to or from about 10% to about 15%, or can be about 15%.

In one aspect, the amount of carbon black (dry weight) in the compositions disclosed herein can range from about 1% to about 40% by weight of the aqueous-based compositions described herein. In another aspect, the amount of carbon black can range from about 1% to about 40%, about 1% to about 35%, about 5% to about 30%, about 10% to about 25%, or about 10% to about 20% by weight of the aqueous-based compositions.

### C. Graphite

In another aspect, the aqueous-based adhesive compositions described herein can include graphite. In one aspect, the graphite can be a natural graphite, a synthetic graphite, or a combination thereof.

In one aspect, the particle size of the graphite ranges from about 10 μm to about 150 μm. In another aspect, the particle size of the graphite ranges from about 10 μm to about 75 μm. In a further aspect, the particle size of the graphite ranges from about 10 μm to about 50 μm.

In one aspect, the amount of graphite (dry weight) present in the aqueous-based adhesive compositions disclosed herein ranges from about 1 to about 40 percent by weight. In a further aspect, the amount of graphite in the compositions disclosed herein ranges from about 1% to about 20% by weight. In a still further aspect, the amount of graphite is about 4.5%, about 5%, about 5.5%, about 6%, about 6.5%, about 7%, about 7.5%, about 8%, about 8.5%, about 9%, about 9.5%, about 10%, about 10.5%, about 11%, about 11.5%, about 12%, about 12.5%, about 13%, or about 13.5% by weight of the compositions disclosed herein.

In one aspect, graphite having CAS no. 7782-42-5 can be used herein. In one aspect, T, KS, and SFG synthetic graphites available from Timcal and the PG and FR natural graphites available from Timcal can be used herein.

In another aspect, carbon black and graphite can be used in combination. In another aspect, the composition is from about 1 to about 30% by weight graphite and at least 1% by weight carbon black, or from 1% to 50%, 2% to 40%, or 3% to 30%. For example, TIMREX® NeroMix E series (e.g., E10) manufactured by Timcal, which is an aqueous dispersion of graphite and carbon black, can be used herein.

### D. Additional Components

In one aspect, the aqueous-based adhesive compositions described herein can include one or more surfactants. In a further aspect, the surfactants may also act as emulsifiers. In an additional aspect, the surfactant can be an anionic surfactant, a nonionic surfactant, or a combination thereof.

Numerous nonionic surfactants can be used in the aqueous-based adhesive compositions described herein. Nonionic surfactants useful herein include alkoxylated fatty acid esters, alkoxylated fatty alcohols, alkyl glucosides, alkyl polyglucosides, amine oxides, cocoamine oxide, glyceryl monohydroxystearate, glyceryl stearate, hydroxy stearic acid, lauramine oxide, laureth-2, polyhydroxy fatty acid amides, polyoxyalkylene stearates, propylene glycol stearate, sorbitan monostearate, sucrose cocoate, sucrose esters, sucrose laurate, steareth-2, and mixtures thereof. Several commercial forms of nonionic surfactants are also useful herein; these include, but are not limited to, Triton® X-180, Triton® X-193, and Triton® X-405 available from Dow Chemical; and Empilan® MAA and Emplian® NP-S from Albright and Wilson, Ltd. In one aspect, the nonionic surfactant can be an alkoxylated fatty alcohol. In another aspect, the alkoxylated fatty alcohol is a C₉-C₁₁ alcohol having an average of approximately 6 moles of ethylene oxide per mole of alcohol, having a density of approximately 0.976 kg/L, having an HLB number of about 12.5, and having a kinematic viscosity at 40° C. of about 21 cSt, such as, for example, TOMADOL® 91-6 manufactured by Air Products or NEODOL® 91-6 manufactured by Shell Chemicals.

Numerous anionic surfactants can be used in the aqueous-based adhesive compositions described herein. In one aspect, the anionic surfactant can be alcohol phosphates and phosphonates, alkyl alkoxy carboxylates, alkyl aryl sulfates, alkyl aryl sulfonates, alkyl carboxylates, alkyl ether carboxylates, alkyl ether sulfates, alkyl ether sulfonates, alkyl phosphates, alkyl polyethoxy carboxylates, alkyl polyglucosides, alkyl polyglucoside sulfates, alkyl polyglucoside sulfonates, alkyl succinamates, alkyl sulfates, alkyl sulfonates, aryl sulfates, aryl sulfonates, fatty taurides, isethionates, N-acyl taurates, nonoxynol phosphates, octoxynol phosphates, sarcosinates, sulfated fatty acid esters, taurates, and mixtures thereof. Several commercial forms of anionic surfactants are also contemplated as being useful herein; in one aspect, the sulfated fatty acid known as Modical® S, manufactured by the Henkel Corporation, may be used.

In one aspect, the surfactant can be from about 0.05% to about 5%, or from about 0.1 to about 2% by weight, of the aqueous-based adhesive compositions disclosed herein.

In one aspect, the aqueous-based adhesive compositions described herein can include stabilizers. In one aspect, the stabilizer can be an acidic pH material such as, for example, an alpha or beta hydroxycarboxylic acid. The alpha or beta hydroxycarboxylic acid may be selected from the group comprising salicylic acid, glycolic acid, mandelic acid, lactic acid, tartaric acid, malic acid, citric acid, isocitric acid, alpha hydroxybutanoic acid, alpha hydroxyhexanoic acid, alpha hydroxyoctanoic acid, alpha hydroxynonanoic acid, alpha hydroxydecanoic acid, alpha hydroxyundecanoic acid, alpha hydroxydodecanoic acid, alpha hydroxytetradecanoic acid, alpha hydrocyhexadecanoic acid, alpha hydroxyoctadecanoic acid, alpha hydroxyoctaeicosanoic acid, dicarboxylic alpha hydroxy acids, 2-hydroxy propanedioic acid, 2-hydroxy hexanedioic acid, 2-hydroxy octanedioic acid, 2-hydroxy decanedioic acid, 2-hydroxy dodecanedioic acid, 2-hydroxy myristicdioic acid, 2-hydroxy palmiticdioic acid, tricarboxylic alpha hydroxy acid, their ester or salt derivatives, or combinations thereof. The above list of compounds is not meant to be limiting and various other stabilizers known in the art can be used herein.

In another aspect, the stabilizer can be a basic pH material such as, for example, caustic soda, caustic potash, ammoniated tallow, dimethyl amine, ammonia, dimethyl amino ethanol, urea, diethanolamine, triethanolamine, or morpholine.

In one aspect, the stabilizer can be from about 0.1 to about 1.0%, or from about 0.1 to about 0.3% of the aqueous-based adhesive compositions.

In one aspect, the aqueous-based adhesive compositions described herein can include one or more chelating agents. In one aspect, the chelating agent comprises a polyamine or the salt thereof. The term “polyamine” as used herein is defined as any compound that possesses two or more substituted or unsubstituted amino groups (mono-, di, -tri-). In certain aspects, the polyamine can include one or more additional groups that can function as a ligand. For example, the polyamine can include one or more hydroxyl groups, alkoxy groups, thiol groups, carboxyl groups, or any other group that can behave as a ligand. In one aspect, the polyamine can be anionic species (i.e., a salt). For example, the neutral compound ethylenediaminetetraacetic acid (EDTA) can be deprotonated with a base in order to produce the corresponding carboxylate salt.

In one aspect, the chelating agent comprises ethylenediaminetetraacetic acid (EDTA), disodium EDTA, an alkali or alkaline metal salt of EDTA, alkali metal citrate, citric acid, iminodiacetic acid, gluconate, NTA, tetraamidomacrocyclic ligand, diethylenetriaminepentaacetic acid, N,N,N′,N′-tetrakis-(2-hydroxypropyl)-ethylenediamine, N-hydroxyethyl-ethylenediaminetriacetic acid (HEDTA), diethylenetriaminepentaacetic acid (DTPA), 1,2,4-triazole (TAZ), benzotriazole, tolyltriazole, 5-phenyl-benzotriazole, 5-nitro-benzotriazole, 3-amino-5-mercapto-1,2,4-triazole, 1-amino-1,2,4-triazole, hydroxybenzotriazole, 2-(5-amino-pentyl)-benzotriazole, 1-amino-1,2,3-triazole, 1-amino-5-methyl-1,2,3-triazole, 3-amino-1,2,4-triazole, 3-mercapto-1,2,4-triazole, 3-isopropyl-1,2,4-triazole, 5-phenylthiol-benzotriazole, halo-benzotriazoles, naphthotriazole, 2-mercaptobenzoimidizole, 2-mercaptobenzothiazole, 4-methyl-2-phenylimidazole, 2-mercaptothiazoline, 5-aminotetrazole, 5-amino-1,3,4-thiadiazole-2-thiol, 2,4-diamino-6-methyl-1,3,5-triazine, thiazole, triazine, methyltetrazole, 1,3-dimethyl-2-imidazolidinone, 1,5-pentamethylenetetrazole, 1-phenyl-5-mercaptotetrazole, diaminomethyltriazine, mercaptobenzothiazole, imidazoline thione, mercaptobenzimidazole, 4-methyl-4H-1,2,4-triazole-3-thiol, 5-amino-1,3,4-thiadiazole-2-thiol, benzothiazole, tritolyl phosphate, indiazole, 1,2-cyclohexanediamine-N,N,N′,N′-tetraacetic acid (CDTA), or any combination thereof.

In some aspects, a defoamer can be included in the aqueous-based adhesive compositions disclosed herein. In one aspect, the defoamer can be petroleum hydrocarbons, fatty alcohols, sulfonated oils, organic phosphates, silicone fluids, dimethylpolysiloxanes, polyalkoxylated polyethers, mineral oils, vegetable oils, or a to combination thereof. The defoamer may further comprise a wax, hydrophobic silica, or a combination thereof. In a further aspect, the wax can be ethylene bis-stearamide, paraffinic waxes, ester waxes, and fatty alcohol waxes. Various commercial defoamers are also contemplated; these include, but are not limited to: Foamkill® 600 Series from Crucible Chemical, Foammizer® M-55 from C. P. Hall, and Nalco® 5770 and 5772 from Nalco Chemical. In one aspect, Foamaster® 111 from Henkel Corporation can be used as the defoamer. Certain bactericides such as Amerstate® 251 from Drew Chemical may also reduce foaming. The above list of compounds is not meant to be limiting and various other defoamers known in the art can be used herein.

In one aspect, the defoamer can be from about 0.1% to about 1.0%, or from about 0.1% to about 0.5% of the aqueous-based adhesive compositions.

In other aspects, the compositions disclosed herein can include one or more fillers. Fillers can be used as thickeners to provide body to the aqueous-based compositions disclosed herein. Examples of fillers useful herein include, but are not limited to, clays, aluminum iron magnesium silicate, aluminum silicon oxide, aluminum silicate, calcium magnesium carbonate, calcium silicate hydrate, calcium carbonate, calcium metasilicate, silica anhydrite+kaolinite, magnesium aluminum silicate hydrate, magnesium aluminum silicate hydrate, magnesium silicate, magnesium silicate hydrate, silicon dioxide, silicon oxide, and mixtures thereof. In one aspect, RC-32 clay slurry manufactured by Thiele Kaolin Company can be used as the filler. The above list of compounds is not meant to be limiting and various other fillers known in the art are also considered and should be considered to be within the scope of this invention.

In one aspect, the filler can be from about 1% to about 15%, from about 5% to about 10%, or from about 8% to about 10% by weight of the aqueous-based adhesive compositions.

In one aspect, a biocide can be added to the adhesive compositions disclosed herein. In one aspect, the biocide can be Rocima® BT 2S biocide manufactured by Rohm and Hass, which is dipropylene glycol, benzisothiazolin-3-one, water, and sodium hydroxide. In another aspect, the biocide can be BIOCHEK° 721M manufactured by the LANXESS Corporation. This product is composed of the active ingredients 1,2-dibromo-2,4-dicyanobutane and 2-bromo-2-nitropropane-1,3-diol. Other biocides known in the art can be used herein.

In one aspect, the biocide can be from about 0.01 to about 0.3%, from about 0.05 to about 0.2%, or from about 0.1 to about 0.2% by weight of the aqueous-based adhesive compositions.

Other additives can be used herein. In some aspects, fungicides, preservatives, hydrocarbons, and mineral oils, or any combination thereof, may also be included in the aqueous-based adhesive compositions disclosed herein. In certain aspects, care should be taken in the selection of any additive listed above that it does not increase the viscosity of the aqueous-based adhesive compositions to such a level that will prevent the use of said adhesives in aerosol form or in pressurized canister dispensers, or in other dispensers known in the art.

The above listed grouping of additives is intended to be exemplary only. Some listed additives may fall into multiple categories (e.g. silica and/or silicates may function as defoamers and also as filler). Listing a compound or constituent in one category should not be construed as limiting that constituent's function to said category. Various other additives known in the art may be incorporated into the compositions and formulations disclosed herein and should also be considered within the scope of this invention.

### E. Propellants

In one aspect, the aqueous-based adhesive compositions described herein can be combined with a propellant in a suitable container in order to aid dispersal. In one aspect, the propellant can be a compressed gas, an inert gas, a hydrofluoroalkane, hydrofluoroalkene, fluorocarbon, or any combination thereof.

Examples of compressed gas include, but are not limited to, carbon dioxide, nitrous oxide, compressed air, nitrogen, argon, or a mixture thereof.

Examples of hydrofluoroalkanes include, but are not limited to, difluoromethane, sometimes known as HFC-32; pentafluoroethane, sometimes known as HFC-125; 1,1,1,2-tetrafluoroethane, sometimes known as HFC-134a; 1,1-difluoroethane, sometimes known as HFC-152; 1,2-difluoroethane, sometimes known as HFC-152a; 1,1,1,2,3,3,3-heptafluoropropane, sometimes known as HFC-227ea; 1,1,1,3,3,3-hexafluoropropane, sometimes known as HFC-236fa; or a mixture thereof.

Examples of hydrofluoroalkenes include, but are not limited to, trans-1,3,3,3-tetrafluoroprop-1-ene, sometimes known as HFO-1234ze, or 2,3,3,3-tetrafluoropropene, sometimes known as HFO-1234yf, or a mixture thereof.

It is to be understood that many of the above-listed components fall into multiple categories (e.g. pentafluoroethane may be considered a fluorocarbon and/or a hydrofluoroalkane, and HFO-1234ze may be considered a hydrofluoroalkene and/or a volatile organic compound) and that inclusion of a propellant in one of the listed categories is not to be construed in any way as limiting. Other propellants known in the art can be used herein.

The amount of propellant that can be used will vary depending upon the composition of the aqueous-based adhesive composition, the internal volume of the pressurized container, and the rate of mixing between the aqueous-based adhesive composition and propellant. In one aspect, the amount of propellant introduced into the pressurized delivery device produces a vapor pressure between 30 to 160 at 72° F., between 50 to 160 at 72° F., between 60 to 120 at 72° F., between 60 to 90 at 72° F., or between 65 to 80 psi at 72° F. In another aspect, the amount of aqueous-based adhesive composition is from 10 to 90% by weight and the propellant is from 10 to 90% by weight, from 60 to 90% by weight of aqueous-based adhesive composition and from 10 to 40% by weight propellant, or from 75 to 90% by weight aqueous-based adhesive composition and from 10 to 25% by weight propellant. The compositions can be packaged in an industry standard pressurized delivery device such as, for example, aerosol cans or propane type cylinders fitted with a suitable valve system and nozzle. Depending upon the type and amount of propellant used, the propellant can also act as a solvent, where it can dilute or thin the aqueous-based adhesive composition.

The aqueous-based adhesive compositions when combined with the propellant possess good release and spray properties when dispensed from the pressurized delivery device. The compositions maintain a relatively low internal pressure in the to pressurized delivery device, which is desirable with respect to releasing the adhesive from the device in a consistent and even manner. In one aspect, spray out pressure fluctuation is between 0-60 psi at 72° F., preferably between 0-10 psi at 72° F.

### Preparation of Aqueous-Based Adhesive Compositions

The aqueous-based adhesive compositions disclosed herein can be produced by the process comprising admixing an aqueous-based adhesive with carbon black, graphite, or a combination thereof. In one aspect, the carbon black and/or graphite are added to the aqueous-based adhesive with stirring to produce a base mixture. In a further aspect, other additives can be added to this base admixture sequentially or concurrently. The components are admixed for a sufficient time in order to produce a homogeneous mixture. In certain aspects, the mixture can be filtered prior to use to remove larger particles. The Examples provide non-limiting procedures for making the aqueous-based adhesive compositions described herein.

The aqueous-based adhesive compositions include water. The water can be added during the process of making the composition. Additionally, the water can come from the aqueous-based adhesives and or carbon black/graphite dispersions. In one aspect, the aqueous-based adhesive composition can be composed of at least 10%, 20%, 30%, 40%, 50%, 60%, 70%, 80%, or 90% by weight water.

In one aspect, the pH of the aqueous-based adhesive compositions disclosed herein can be adjusted as needed. In one aspect, the pH of the aqueous-based adhesive compositions ranges from about 6.5 to about 9. In another aspect, the pH of the aqueous-based adhesive composition ranges from about 7.5 to about 8.6.

In another aspect, the viscosities of the aqueous-based adhesive compositions are low enough so that the compositions can be applied by spraying. In one aspect, the Brookfield RVF (spindle #4 at 30 rpm) viscosities of the compositions can be from about 100 centipoise to about 1,300 centipoise. In another aspect, the viscosities of the compositions can be from about 100 centipoise to about 1,000 centipoise, or in another aspect, can be from about 100 centipoise to about 120 centipoise.

In one aspect, the adhesive-based compositions are substantially free of volatile organic compounds (VOCs). For example, the compositions can have less than 10% by weight, less than 5% by weight, less than 1% by weight, less than 0.5% to by weight, or less than 0.1% by weight VOC. In another aspect, the composition has no VOCs.

### Applications of Aqueous-Based Adhesive Compositions

In addition to the aqueous-based adhesive compositions disclosed herein, and methods of making thereof, a method for adhering an article to a substrate is provided. In one aspect, this method involves applying the aqueous-based adhesive composition to a substrate to coat the substrate and then applying the article to the substrate. In another aspect, this method involves applying the aqueous-based adhesive composition to an article to coat the article and then applying the article to the substrate. In a further aspect, this method involves applying the aqueous-based adhesive composition to the substrate and article to coat the substrate and article and then applying the coated article to the coated substrate.

In one aspect, the article is any ESD flooring material. In this aspect, the ESD flooring material is any material that can conduct or dissipate electrostatic energy. In one aspect, the article includes carpet, carpet padding, athletic surfaces, vinyl composite tile, vinyl tile, wall tile, resilient sheet goods, ceramic tile, wood flooring, wall covering, synthetic flooring material, cove base, a laminate, linoleum, a wall panel, fiber reinforced plastic, or floor covering padding. In another aspect, the substrate comprises styrofoam, textile fabrics, natural and synthetic fibers, Formica, wood, metals, fiberglass, concrete, sheet rock, masonry materials, plastic, vinyl, glass, leather, or rubber. The aqueous-based adhesive compositions described herein are useful in situations where it is desirable or necessary to encourage proper static control. In one aspect, the aqueous-based adhesive compositions described herein can be part of an effective ESD flooring system. In one aspect, the adhesive composition when used to adhere the article to the substrate can enable conductive flooring to properly ground ESD systems according to conductive flooring standards. In other aspects, the adhesive composition can enable dissipative flooring to properly ground ESD systems according to the dissipative flooring standards. In either case, the adhesive composition is in integral part of a properly performing ESD flooring system.

The aqueous-based adhesive compositions described herein are also unique in that they provide performance enhancements that cannot be found in other ESD to adhesives. Since the solution is water based, there is no VOC emitted during drying, like in epoxy based systems. Further, the amount of adhesive used is much less than other system, which provides a better environmental impact and less chance of adhesive show-through (telegraphing) when dry. Because the adhesives dry to the touch prior to installing flooring and the product does not contain any slow setting polymers, the flooring can be installed and immediately walked on or used for trade traffic. Finally, the aqueous based system dries completely and is resistant to chemical breakdown by high pH water. This is something current adhesives, including epoxies, are not able to withstand. In one aspect, the adhesive composition can withstand 90% RH when measured by ASTM F2170 and up to 10 lbs moisture when measured by ASTM F1869, and a pH of up to 11. Current ESD adhesives are not able to withstand and survive these environmental conditions.

Not wishing to be bound by theory, the carbon black and/or graphite present in the aqueous-based adhesive compositions are conductive and provide full support for proper ESD flooring and other surfaces. The aqueous-based adhesive compositions provide electrical continuity among all the individual vinyl tiles, carpet tiles, etc. in a room.

### EXAMPLES

The following examples are put forth so as to provide those of ordinary skill in the art with a complete disclosure and description of how the compositions and methods described and claimed herein are made and evaluated, and are intended to be purely exemplary and are not intended to limit the scope of what the inventors regard as their invention. Efforts have been made to ensure accuracy with respect to numbers (e.g. amounts, temperature, etc.) but some errors and deviations should be accounted for. Unless indicated otherwise, parts are parts by weight, temperature is in ° C. or is at ambient temperature, and pressure is at or near atmospheric. There are numerous variations and combinations of reaction conditions, e.g. component concentrations, desired solvents, solvent mixtures, temperatures, pressures, and other reaction ranges and conditions that can be used to optimize the produce purity and yield obtained from the described process. Only reasonable and routine experimentation will be required to optimize such process conditions.

When test formulations were filtered, a 250 micron pore size was used. High viscosity prevented filtration of some samples.

### I. Preparation of Adhesives

### Example 1

Water, Foamaster® III, and Rhoplex® N-619 were charged into a suitable vessel and mixed for approximately 15 minutes. Coadis™ 123K was added to the vessel and the contents were mixed for a further 10 minutes. Ensaco® 250 Granular was then added to the vessel and the contents were stirred for an additional 30 minutes. Percentages by weight of each component are provided in Table 1 below.

TABLE 1
Example 1 Composition

| Component | Weight Percent |
|---|---|
| Water | 22.70% |
| Foamaster III | 0.25% |
| Rhoplex N-619 | 56.30% |
| Coadis 123K | 12.60% |
| Ensaco 250 Granular | 8.15% |

The pH of the Example 1 formulation was 7.8 and the viscosity was 1,300 centipoise. The test formulation was not filtered prior to use and was mixed with propellant HFC 152a in a ratio of 75:25 aqueous-based adhesive composition:propellant. The spray was found to have a medium particle size and a steady discharge. The test formulation of Example 1 was used to apply backer board to a substrate. Testing of the formulation indicated passing marks according to current ESD standards.

### Example 2

Rhoplex® N-619 and Timcal® NeroMix Aqueous Dispersion were charged into a suitable vessel and mixed for approximately 30 minutes. Percentages by weight of each component are provided in Table 2 below.

TABLE 2
Example 2 Composition

| Component | Weight Percent |
|---|---|
| Rhoplex ® N-619 | 67% |
| Timcal ® NeroMix Aqueous | 33% |
| Dispersion | |

The pH of the Example 2 formulation was 8.1 and the viscosity was 100 centipoise. The test formulation was filtered prior to use and was mixed with propellant HFC 152a in a ratio of 80:20 aqueous-based adhesive composition:propellant. The spray was found to have a medium particle size and a steady discharge. The test formulation of Example 2 was used to apply backer board to a substrate. A standard multimeter indicated that an almost adequate current was passed on the backer board application.

### Example 3

Rhoplex® N-619 and Foamaster® III were charged into a suitable vessel and mixed for 30-40 minutes. Timrex® NeroMix Aqueous Dispersion Carbon Black was added to the vessel and the contents were mixed for an additional 30-40 minutes. Finally, Biocheck® 721M was added and the solution was mixed for 15-30 minutes. Percentages by weight for each component are provided in Table 3 below.

TABLE 3
Example 3 Composition

| Component | Weight Percent |
|---|---|
| Rhoplex ® N-619 | 55% |
| Foamaster ® III | 0.25% |
| Timrex ® NeroMix Aqueous | 44.7% |
| Dispersion Carbon Black | |
| Biocheck ® 721M | 0.10% |

The pH of the Example 3 formulation was 8.55 and the viscosity was 120 centipoise. The test formulation was filtered prior to use and was mixed with propellant HFC 152a in a ratio of 85:15 aqueous-based adhesive composition:propellant. The spray was found to have a small particle size and a steady discharge. The test formulation of Example 3 was used to apply backer board to a substrate. A standard multimeter indicated adequate current was passed on the backer board application. A 22 ounce can filled with the test formulation and propellant showed steady spray after 3 weeks of shelf life testing at 130° F. (54.4° C.). A compatibility bottle containing this formulation showed minimal separation of polymer and carbon black dispersion after 3-4 weeks.

### Example 4

W-7107 Aurasperse® Carbon Black Pigment Dispersion and water were charged into a suitable vessel and mixed for 20 minutes. Rhoplex® N-619 was added to the vessel and the contents were mixed for an additional 30 minutes. Percentages by weight for each component are provided in Table 4 below.

TABLE 4
Example 4 Composition

| Component | Weight Percent |
|---|---|
| W-7107 Aurasperse ® Carbon | 10% |
| Black Pigment Dispersion | |
| Water | 20% |
| Rhoplex N-619 | 70% |

The pH of the formulation was 7.3 and the viscosity was 1,000 centipoise. The test formulation was not filtered prior to use and was mixed with propellant HFC 152a in a ratio of 85:15 aqueous-based adhesive composition:propellant. The spray was found to have a large particle size and a steady discharge. The test formulation of Example 4 was used to apply backer board to a substrate. A standard multimeter indicated inadequate current was passed on the backer board application.

### Example 5

Rhoplex® N-619 and water were charged into a suitable vessel and mixed for 10 minutes. W-7017 Aurasperse® Carbon Black Pigment Dispersion was added to the vessel and the contents were mixed for an additional 30 minutes. Percentages by weight for each component are provided in Table 5 below.

TABLE 5
Example 5 Composition

| Component | Weight Percent |
|---|---|
| Rhoplex ® N-619 | 80.5% |
| Water | 4.5% |
| W-7107 Aurasperse ® Carbon | 15% |
| Black Pigment Dispersion | |

The pH of the Example 5 formulation was 7.0 and the viscosity was 1,050 centipoise. The test formulation was not filtered prior to use and was mixed with propellant HFC 152a in a ratio of 80:20 aqueous-based adhesive composition:propellant. The spray was found to have a large particle size. The test formulation of Example 5 was used to apply backer board to a substrate. A standard multimeter indicated inadequate current was passed on the backer board application.

### Example 6

Water, Foamaster® III, and Rhoplex® N-619 were charged into a suitable to vessel and mixed for 15 minutes. Coadis™ 123K was added to the vessel and the contents were mixed for 10 minutes. Ensaco® 250 Granular was then added to the vessel and the contents were mixed for an additional 30 minutes. Percentages by weight for each component are provided in Table 6 below.

TABLE 6
Example 6 Composition

| Component | Weight Percent |
|---|---|
| Water | 15% |
| Foamaster ® III | 0.25% |
| Rhoplex ® N-619 | 66.25% |
| Coadis ™ 123K | 15% |
| Ensaco ® 250 | 3.5% |
| Granular | |

The pH of the Example 6 formulation was 8.0 and the viscosity was 975 centipoise. The test formulation was only partially filterable and was mixed with propellant HFC 152a in a ratio of 75:25 aqueous-based adhesive:propellant. The spray was found to have a medium particle size. The test formulation of Example 6 was used to apply backer board to a substrate. A standard multimeter indicated inadequate current was passed on the backer board application.

### Example 7

Coadis™ 123K, Foamaster® III, and Ensaco® 250 Powder were charged into a suitable vessel. An amount of water equal to 20% by weight of the final composition was added to the vessel and the contents were mixed for 20 minutes. Saitack® 970 and an additional amount of water (equal to 5% by weight of the final composition) were added to the vessel and the contents were mixed for an additional 30 minutes. Ensaco® 250 Granular and an additional amount of water (equal to 5% by weight of the final composition) were added to the vessel and the contents were mixed for 20 minutes. Percentages by weight of each component in the final composition are to provided in Table 7 below.

TABLE 7
Example 7 Composition

| Component | Weight Percent |
|---|---|
| Water | 30% |
| Coadis ™ 123K | 15% |
| Foamaster ® III | 0.25% |
| Ensaco ® 250 Powder | 2.5% |
| Saitack ® 970 | 49.75% |
| Ensaco ® 250 | 2.5% |
| Granular | |

The pH of the Example 7 formulation was 6.7 and the viscosity was 850 centipoise. The test formulation was not filtered prior to use and was mixed with propellant HFC 152a in a ratio of 75:25 aqueous-based adhesive composition:propellant. The spray was found to have a medium particle size and a steady discharge. The test formulation of Example 7 was used to apply backer board to a substrate. A standard multimeter indicated inadequate current was passed on the backer board application.

### Example 8

Coadis™ 123K, Foamaster® III, and Ensaco® 250 Powder were charged into a suitable vessel. An amount of water equal to 25% by weight of the final composition was added to the vessel and the contents were mixed for 20 minutes. Ensaco® 250 Granular and an additional amount of water (equal to 5% by weight of the final composition) were added to the vessel and the contents were mixed for 30 minutes. Percentages by weight of each component in the final composition are provided in Table 8 below.

TABLE 8
Example 8 Composition

| Component | Weight Percent |
|---|---|
| Water | 30% |
| Coadis ™ 123K | 15% |
| Foamaster ® III | 0.25% |
| Rhoplex ® N-619 | 50.75% |
| Ensaco ® 250 | 4% |
| Granular | |

The pH of Example 8 formulation was 8.35 and the viscosity was 1,100 centipoise. The test formulation was filtered prior to use and was mixed with propellant HFC 152a in a ratio of 80:20 aqueous-based adhesive composition:propellant. The spray was found to have a small particle size and a steady discharge. The test formulation of Example 8 was used to apply backer board to a substrate. A standard multimeter indicated inadequate current was passed on the to backer board application.

### Example 9

Using the procedures discussed above, an adhesive composed of the following components was prepared (amounts in weight %):

### Saiden SA-207: 12.8%

### Acronal 3432: 2.0%

### Acronal V-275: 23.4%

### Water: 1.8%

### Timrex NeroMix E-10: 55%

### Benzoflex 2088: 4.3%

### Triton X-405: 0.6%

### Biochek 721M: 0.1%

### II. Evaluation of Adhesive

The adhesive in Example 3 was evaluated using the following ESD Association test methods:

### ANSI/ESD S7.1-2005

### ANSI/ESD STM 97.1-2006

### ANSI/ESD STM 97.2-2006

Three flooring samples, mounted to concrete boards, were submitted by the client for testing. Two of sample floors were ESD vinyl tiles while the third was and to ESD carpet tile. Each sample had a least two groundable points for testing purposes.

### ANSI/ESD S7.1—Floor Materials

ANSI/ESD S7.1 “provides test methods for measuring the electric resistance of floor materials used for the control of electrostatic charge and discharge. The standard provides test methods for the qualification of floor materials prior to their installation or application, as well as test methods for acceptance and monitoring of the qualification of floor materials prior to their installation or application, as well as test methods for acceptance and monitoring of floor materials after installation or application.”

Testing was conducted in an environmental chamber set for 73° F. and 12% relative humidity. The samples were conditioned for a minimum of 72 hours. Point to point and point to groundable point measurements were made on each sample. The test was then repeated after the samples were conditioned at 73° F. and 50% relative humidity for 72 hours.

A Prostat PRS-801 Resistance System was used for all measurements. This resistance meter meets the “Resistance Measuring Meter” requirements of ANSI/ESD S7.1-2005.

ANSI/ESD S7.1-2005 defines flooring measured using the procedure as either Conductive or Dissipative. A Conductive Floor has a resistance to ground of less than 1.0×10⁶ ohms A Dissipative Floor has a resistance to ground between 1.0×10⁶ and 1.0×10⁹ ohms.

The minimum, maximum, average and median values for each of the flooring samples were calculated. The results are provided below (GpA—Groundable Point “A”: P-P—Point to point).

| Floor Type | Test Location | Min. | Max. | Average | Median |
|---|---|---|---|---|---|
| ESD Carpet | Resistance to GpA | 4.8 × 10⁴ | 1.6 × 10⁵ | 8.2 × 10⁴ | 6.8 × 10⁴ |
| | Resistance to GpB | 4.0 × 10⁴ | 1.6 × 10⁵ | 7.7 × 10⁴ | 5.9 × 10⁴ |
| | Resistance to P-P | 7.2 × 10⁴ | 1.3 × 10⁵ | 9.1 × 10⁴ | 8.7 × 10⁴ |
| | Position A Fixed | | | | |
| | Resistance P-P | 7.1 × 10⁴ | 1.1 × 10⁵ | 8.4 × 10⁴ | 7.8 × 10⁴ |
| | Position B Fixed | | | | |
| Green Vinyl | Resistance to GpA | 2.4 × 10⁵ | 3.2 × 10⁵ | 2.8 × 10⁵ | 2.9 × 10⁵ |
| Tile | Resistance to GpB | 3.0 × 10⁵ | 4.4 × 10⁵ | 3.8 × 10⁵ | 3.8 × 10⁵ |
| | Resistance P-P | 3.4 × 10⁵ | 6.9 × 10⁵ | 4.9 × 10⁵ | 4.6 × 10⁵ |
| | Position A Fixed | | | | |
| | Resistance P-P | 3.7 × 10⁵ | 7.8 × 10⁵ | 5.4 × 10⁵ | 5.3 × 10⁵ |
| | Position B Fixed | | | | |
| White Vinyl | Resistance to GpA | 4.9 × 10⁴ | 7.5 × 10⁴ | 6.2 × 10⁴ | 6.2 × 10⁴ |
| Tile | Resistance to GpB | 5.9 × 10⁴ | 8.0 × 10⁴ | 6.5 × 10⁴ | 6.3 × 10⁴ |
| | Resistance P-P | 4.4 × 10⁴ | 6.4 × 10⁴ | 5.7 × 10⁴ | 5.9 × 10⁴ |
| | Position A Fixed | | | | |
| | Resistance P-P | 5.0 × 10⁴ | 6.6 × 10⁴ | 5.9 × 10⁴ | 6.0 × 10⁴ |
| | Position B Fixed | | | | |

### Moderate Relative Humidity Summary:

| Floor Type | Test Location | Min. | Max. | Average | Median |
|---|---|---|---|---|---|
| ESD Carpet | Resistance to GpA | 6.6 × 10⁴ | 1.1 × 10⁵ | 9.3 × 10⁴ | 9.2 × 10⁴ |
| | Resistance to GpB | 5.7 × 10⁴ | 1.2 × 10⁵ | 7.5 × 10⁴ | 7.0 × 10⁴ |
| | Resistance P-P | 7.0 × 10⁴ | 1.1 × 10⁵ | 8.9 × 10⁴ | 8.9 × 10⁴ |
| | Position A Fixed | | | | |
| | Resistance P-P | 7.2 × 10⁴ | 1.0 × 10⁵ | 8.9 × 10⁴ | 9.2 × 10⁴ |
| | Position B Fixed | | | | |
| Green Vinyl | Resistance to GpA | 3.0 × 10⁵ | 3.9 × 10⁵ | 3.3 × 10⁵ | 3.2 × 10⁵ |
| Tile | Resistance to GpB | 2.9 × 10⁵ | 3.8 × 10⁵ | 3.4 × 10⁵ | 3.5 × 10⁵ |
| | Resistance P-P | 2.9 × 10⁵ | 4.6 × 10⁵ | 3.7 × 10⁵ | 3.8 × 10⁵ |
| | Position A Fixed | | | | |
| | Resistance P-P | 3.2 × 10⁵ | 5.5 × 10⁵ | 4.2 × 10⁵ | 4.2 × 10⁵ |
| | Position B Fixed | | | | |
| White Vinyl | Resistance to GpA | 6.3 × 10⁴ | 8.3 × 10⁴ | 7.3 × 10⁴ | 7.7 × 10⁴ |
| Tile | Resistance to GpB | 5.9 × 10⁴ | 8.7 × 10⁴ | 7.4 × 10⁴ | 7.4 × 10⁴ |
| | Resistance P-P | 4.5 × 10⁴ | 7.2 × 10⁴ | 6.2 × 10⁴ | 6.4 × 10⁴ |
| | Position A Fixed | | | | |
| | Resistance P-P | 5.2 × 10⁴ | 8.1 × 10⁴ | 6.8 × 10⁴ | 7.0 × 10⁴ |
| | Position B Fixed | | | | |

### Conclusion

All three of the supplied flooring would be classified as Conductive based on ANSI/ESD S7.1-2005.

ANSI/ESO STM 97.1—Floor Materials and Footwear in Combination with a Person

ANSI/ESD STM 97.1 “provides a test method for measuring the electrical system resistance of floor materials in combination with persons wearing static control footwear.” Due to the wide variation in types and resistance values for ESD footwear this test series utilized an ESD sole grounder. Sole grounders, on average, tend to function better over a wide variety of ESD flooring types. A Prostat PRS-801 Resistance System was used for all measurements. This resistance meter meets the “Resistance Measuring Meter” requirements of ANSI/ESD STM 97.1-2006.

The minimum, maximum, average and median values for each of the Flooring/Footwear samples were calculated.

| Floor Type | Minimum | Maximum | Average | Median |
|---|---|---|---|---|
| ESD Carpet | 6.6 × 10⁵ | 1.2 × 10⁶ | 9.9 × 10⁵ | 1.1 × 10⁶ |
| Green Vinyl Tile | 9.8 × 10⁵ | 1.5 × 10⁶ | 1.3 × 10⁶ | 1.3 × 10⁶ |
| White Vinyl Tile | 7.8 × 10⁵ | 1.2 × 10⁶ | 1.0 × 10⁶ | 1.1 × 10⁶ |

### Conclusion

ANSI/ESD S20.20-2007 is the most referenced ESO Program Standard globally. Based on the measurements taken on the supplied flooring samples, all of the samples, when used in conjunction with two sole grounders, would be classified as Flooring/Footwear Method 1, which has a system resistance of less than 3.5×10⁷ ohms Generally, when the system resistance of a Flooring/Footwear System is less than 3.5×10⁷ ohms, the voltage on the person's body will be less than 100 volts when walking on static control flooring.

ANSI/ESD STM 97.2—Floor Materials and Footwear—Voltage Measurement in Combination with a Person

ANSI/ESD STM 97.2 “provides test methods for the measurement of voltage on a person where protection of ESD susceptible items is required.”

The minimum, maximum, average and median values for each of the Flooring/Footwear samples were calculated.

| Floor Type | Minimum | Maximum | Average | Median |
|---|---|---|---|---|
| ESD Carpet | −8 volts | +3 volts | −4.9 volts | −6 volts |
| Green Vinyl Tile | −8 volts | +5 volts | −4.3 volts | −5 volts |
| White Vinyl Tile | −7 volts | +4 volts | −3.7 volts | −5 volts |

### Conclusion

Walking voltage levels at this level would be considered desirable by companies that handle ESD sensitive devices while using a Flooring/Footwear System.

Various modifications and variations can be made to the materials, methods, and articles described herein. Other aspects of the materials, methods, and articles described herein will be apparent from consideration of the specification and practice of the materials, methods, and articles disclosed herein. It is intended that the specification and examples be considered as exemplary.

What is claimed:

1. An aqueous-based adhesive composition comprising a mixture of:
(a) an aqueous-based adhesive, and
(b) carbon black, graphite, or a combination thereof.

2. The composition of claim 1, wherein the aqueous-based adhesive comprises an acrylic emulsion, an acrylic copolymer emulsion, a carboxylated SBR emulsion, or a styrene acrylic copolymer emulsion.

3. The composition of claim 1, wherein the aqueous-based adhesive comprises one or more acrylates.

4. The composition of claim 1, wherein the aqueous-based adhesive comprises an anionic acrylate.

5. The composition of claim 1, wherein the aqueous-based adhesive is from 40 to 90% by weight of the composition.

6. The composition of claim 1, wherein the aqueous-based composition further comprises a nonionic surfactant, an anionic surfactant, or a combination thereof.

7. The composition of claim 6, wherein the nonionic surfactant comprises an ethoxylated alcohol.

8. The composition of claim 1, wherein the carbon black is a powder, granules, or a combination thereof.

9. The composition of claim 1, wherein at least 90% of the carbon black has a particle size less than 20 μm.

10. The composition of claim 1, wherein the carbon black has a BET nitrogen surface area of 10 to 1,300 m²/g as measured by ASTM D3037.

11. The composition of claim 1, wherein the carbon black has an Oil Absorption Number of 100 to 500 ml/100 g as measured by ASTM D2414.

12. The composition of claim 1, wherein the carbon black has a Crushed Oil Absorption Number of 50 to 500 ml/100 g as measured by ASTM D3493.

13. The composition of claim 1, wherein the amount of carbon black is from 1 to 10% by weight of the composition.

14. The composition of claim 1, wherein the graphite comprises natural graphite, synthetic graphite, or a combination thereof.

15. The composition of claim 13, wherein the graphite is from 3 to 15% by weight of the composition.

16. The composition of claim 1, wherein the graphite has a particle size range from 10 μm to 150 μm.

17. The composition of claim 1, wherein the composition further comprises a stabilizer, a defoamer, a filler, a biocide, a fungicide, a preservative, a hydrocarbon or mineral oil, or any combination thereof.

18. The composition of claim 1, wherein the composition is substantially free of a volatile organic compound.

19. An aqueous-based adhesive composition produced by the process comprising admixing:
(a) an aqueous-based adhesive, and
(b) carbon black, graphite, or a combination thereof.

20. An adhesive composition comprising the aqueous-based adhesive composition of claim 1 and a propellant.

21. The composition of claim 20, wherein the propellant comprises a fluorocarbon, an inert gas, a hydrocarbon gas, a hydrofluoroalkane or hydrofluoroalkene, a volatile organic compound, or any combination thereof.

22. The composition of claim 20, wherein the propellant is 1,1,1,2-tetrafluoroethane or 1,1-difluoroethane.

23. The composition of claim 20, wherein the propellant comprises an inert gas.

24. The composition of claim 20, wherein the propellant comprises a blend of two or more propellants.

25. The composition of claim 20, wherein the propellant is a single propellant.

26. The composition of claim 20, wherein the composition is from 10 to 90% by weight of adhesive and from 10 to 90% by weight propellant.

27. A method for adhering an article to a substrate, comprising (a) applying the aqueous-based adhesive composition of claim 1 to the surface of the substrate and/or article and (b) applying the article to the substrate.

28. The method of claim 27, wherein the article comprises carpet, carpet padding, athletic surfaces, vinyl composite tile (VCT), vinyl tile, wall tile, resilient sheet goods, ceramic tile, wood flooring, wall covering, synthetic flooring material, cove base, a laminate, linoleum, a wall panel, a fiber reinforced plastic (FRP), or floor covering padding.

29. The method of claim 27, wherein the substrate comprises Styrofoam, textile fabrics, natural and synthetic fibers, Formica, wood, metals, fiberglass, concrete, sheet rock, masonry materials, plastic, vinyl, glass, leather, or rubber.

30. The method of claim 27, wherein the article comprises an ESD flooring material.

31. The method of claim 27, wherein the conductive adhesive composition facilitates transmission of any static buildup in an ESD flooring system to the properly connected common ground point.
